(19) United States
(12) Patent Application Publication
(10) Pub. No.: US 2010/0031983 A1
(43) Pub. Date: Feb. 11, 2010

(54) SUBSTRATE PROCESSING APPARATUS

(76) Inventor: Hiroshi Ootaguro, Kanazawa-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/534,378

(22) Filed: Aug. 3, 2009

(30) Foreign Application Priority Data
Aug. 5, 2008 (JP) 2008-201956

(51) Int. Cl. B08B 3/04

(52) U.S. Cl. 134/56 R

(57) ABSTRACT

A substrate processing apparatus includes a bath, in which a liquid or a gas is fed, and a mechanism which feeds out a liquid or a gas into the bath. The substrate processing apparatus processes a to-be-processed substrate which is disposed in the bath. At least one rectifying plate is disposed near the to-be-processed substrate between the to-be-processed substrate and the mechanism.

### CROSS-REFERENCE TO RELATED APPLICATIONS

This application is based upon and claims the benefit of priority from prior Japanese Patent Application No. 2008-201956, filed Aug. 5, 2008, the entire contents of which are incorporated herein by reference.

### BACKGROUND OF THE INVENTION

1. Field of the Invention

The present invention relates to a substrate processing apparatus which perform cleaning, film formation, etching, etc. with a liquid or a gas, in a process of fabricating a planar substrate such as a liquid crystal display device, a semiconductor device, or a printed board.

2. Description of the Related Art

In recent years, with an increasing demand for reduction in size and weight of electronic equipment, there also is a demand for reduction in thickness of a substrate such as a printed board.

On the other hand, in the process of fabricating a planar substrate such as a liquid crystal display device, a semiconductor device or a printed board, to improve the in-plane uniformity of the process is always necessary in order to improve the product performance and manufacturing yield. In general, the in-plane uniformity is enhanced if the size of a process bath is sufficiently large, compared to the size of the substrate.

For example, in the manufacture of the liquid crystal display device, in order to enhance the efficiency, large plates, from which plural substrates are to be cut out, are used as a pair of insulative substrates, and a plurality of display devices are formed between the paired insulative substrates. Subsequently, the thickness of the insulative substrate is reduced to a desired thickness by either mechanical polishing or chemical polishing, thereby to reduce, e.g. the weight of the insulative substrate.

Conventionally, there has been proposed a method of manufacturing a liquid crystal display device which improves the manufacturing yield by fabricating a pair of substrates with different temperature histories, bonding these substrates together, and simultaneously reducing the thickness of these substrates by subjecting the major surfaces thereof to a chemical process (see Jpn. Pat. Appln. KOKAI Publication No. 2007-52367).

In recent years, with the increase in size of glass substrates of liquid crystal display devices and in size of silicon wafers of semiconductor devices, if the size of the process bath is increased or if the substrates are moved in the process bath, the processing apparatus would become large in scale. Consequently, it becomes more difficult to decrease processing variances within substrate surfaces or among substrates.

In the case of performing etching, film formation or cleaning with use of a liquid or a gas (hereinafter referred to as “liquid or the like”), the process progresses to a greater degree on that part of the substrate, to which the liquid or the like is jetted, resulting in non-uniformity in in-plane thickness.

For example, in the step of subjecting the glass substrate to chemical polishing to reduce the thickness thereof, the glass substrate is input in a cassette, and immersed in a polishing liquid in the process bath. Then, air is fed out from tubes which are disposed on the bottom part of the process bath, and the polishing liquid is stirred. As described above, when the glass substrate is polished, that part of the glass substrate, to which the air from the tubes is applied, that is, that part of the glass substrate, which is positioned at the bottom part of the process bath, is reduced in thickness, leading to degradation in product performance. Besides, since the end portions of the glass substrate are not usable for product manufacturing, the manufacturing yield would deteriorate.

In particular, in the case where the thickness of the part where an integrated circuit is disposed is non-uniform, there would occur defective implementation of the integrated circuit disposed on the substrate, leading to a decrease in manufacturing yield. Furthermore, in the case where the thickness of a pair of substrates is non-uniform in the manufacturing process of the liquid crystal display device, alignment between parts would become difficult when a liquid crystal display panel is cut out of the paired substrates and the liquid crystal display panel is disposed, for example, in a frame.

### BRIEF SUMMARY OF THE INVENTION

According to a first aspect of the present invention, there is provided a substrate processing apparatus comprising a bath in which a liquid or a gas is fed, and a mechanism which feeds out a liquid or a gas into the bath, the substrate processing apparatus processing a to-be-processed substrate which is disposed in the bath, wherein at least one rectifying plate is disposed near the to-be-processed substrate between the to-be-processed substrate and the mechanism.

According to a second aspect of the present invention, there is provided a substrate processing apparatus comprising a bath in which a liquid or a gas is fed, and a mechanism which feeds out a liquid or a gas into the bath, the substrate processing apparatus processing a to-be-processed substrate which is disposed in the bath, wherein at least one rectifying plate is disposed near an end portion of the to-be-processed substrate, which is not opposed to the mechanism.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows an example of the structure of a to-be-processed substrate which is processed by a substrate processing apparatus according to an embodiment of the present invention;

FIG. 2A is a view for describing a structure example of a substrate processing apparatus according to a first embodiment of the present invention;

FIG. 2B is a view for describing the structure example of the substrate processing apparatus according to the first embodiment of the present invention;

FIG. 3A is a view for describing a structure example of a substrate processing apparatus according to a second embodiment of the present invention;

FIG. 3B is a view for describing the structure example of the substrate processing apparatus according to the second embodiment of the present invention;

FIG. 3C is a view for describing a structure example of a rectifying plate of the substrate processing apparatus according to the second embodiment of the present invention;

FIG. 4A is a view for describing a structure example of a substrate processing apparatus according to a third embodiment of the present invention;

FIG. 4B is a view for describing the structure example of the substrate processing apparatus according to the third embodiment of the present invention; and

FIG. 5 is a graph showing an example of the measurement result of the thickness of a to-be-processed substrate in a case where the to-be-processed substrate was subjected to a polishing process without using a rectifying plate.

### DETAILED DESCRIPTION OF THE INVENTION

A substrate processing apparatus according to a first embodiment of the present invention will now be described with reference to the accompanying drawings. The substrate processing apparatus according to this embodiment is a substrate processing apparatus which is used when a transparent insulative substrate of a liquid crystal display device, which is a to-be-processed body, is subjected to cleaning, film formation, or etching (polishing) with use of a liquid or a gas.

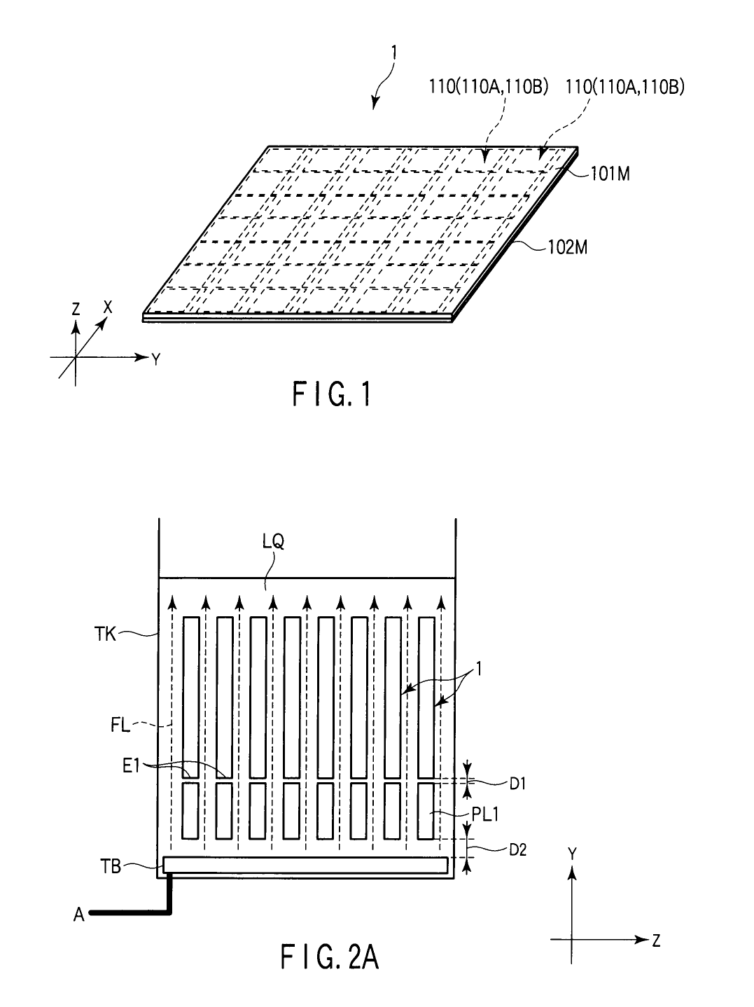

A to-be-processed substrate 1 of the substrate processing apparatus according to this embodiment includes a pair of substantially rectangular transparent insulative substrates which are disposed to be opposed to each other. As shown in FIG. 1, the paired substrates comprise a first substrate 100M and a second substrate 102M which is disposed to be opposed to the first substrate 10M. The first substrate 101M and second substrate 102M are transparent glass substrates.

The first substrate 100M includes a first display region 110A. The first display region 110A includes a plurality of pixel electrodes (not shown) which are arrayed in a matrix, and switching elements which are disposed near the associated pixel electrodes. The first substrate 100M further includes various wiring lines (not shown), such as driving wiring lines, which extend around the first display region 110A, thereby to drive the plural pixel electrodes. The second substrate 102M includes a second display region 110B which includes a counter-electrode that is opposed to the plural pixel electrodes.

The first substrate 100M and the second substrate 102M are aligned such that the first display region 110A and second display region 110B are opposed. In addition, the first substrate 100M and the second substrate 102M are fixed by a sealing member (not shown) which is disposed between the first substrate 101M and the second substrate 102M in a manner to surround the first display region 110A and second display region 110B. The sealing member includes a filling port for filling a liquid crystal material later.

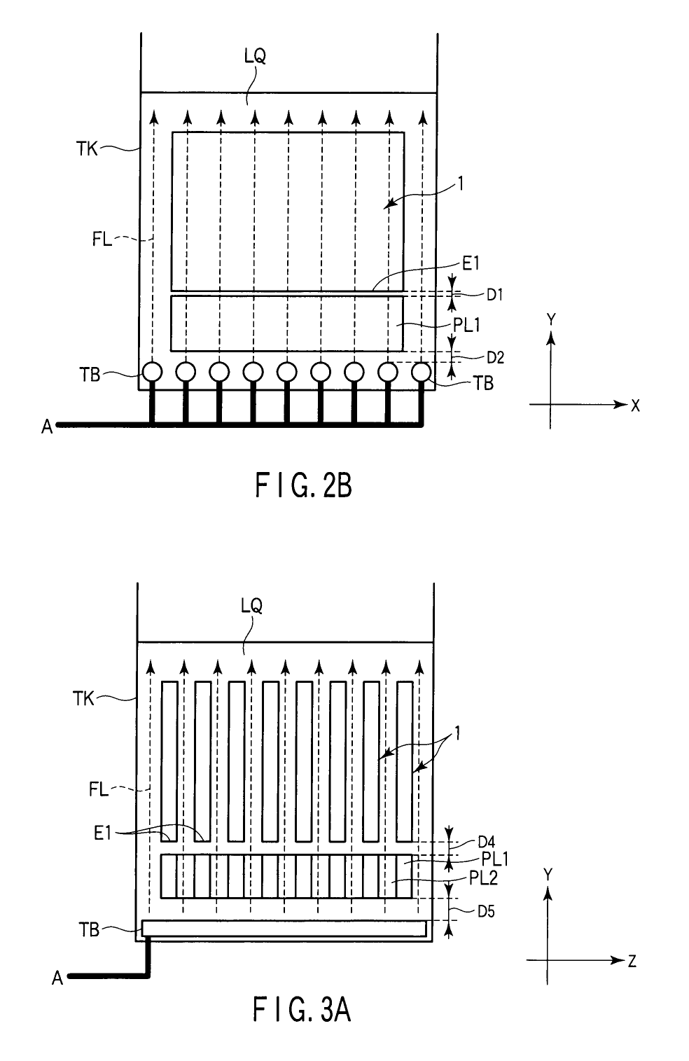

The substrate processing apparatus according to the present embodiment includes a process bath TK in which a liquid or a gas is put, and a feed-out mechanism which feeds out the liquid or gas into the process bath TK. In the substrate processing apparatus shown in FIG. 2, the process bath TK is filled with a polishing liquid LQ for polishing, for example, a to-be-processed body. In the substrate processing apparatus according to the embodiment, a solution containing hydrofluoric acid is used as the polishing liquid LQ. The level of the polishing liquid LQ may be lower than the upper end of the process bath TK. Alternatively, the polishing liquid LQ may be successively fed to overflow, and may be circulated.

When the to-be-processed substrates 1 are subjected to a polishing process as to-be-processed bodies, the to-be-processed substrates 1 are arranged in a cassette (not shown) or the like, and the to-be-processed substrates 1 in the cassette are immersed in the polishing liquid in the process bath TK. The to-be-processed substrates 1 are arranged such that their to-be-processed surfaces (substantially parallel to an XY plane) are substantially perpendicular to the bottom surface (substantially parallel to a ZX plane) of the process bath TK and that the to-be-processed surfaces are juxtaposed at intervals so as not to contact each other.

The feed-out mechanism for feeding out the liquid or gas into the process bath TK is disposed on the bottom of the process bath TK. As shown in FIG. 2A and FIG. 2B, in the substrate processing apparatus according to the embodiment, the feed-out mechanism includes a plurality of tubes TB extending in a direction (Z direction) substantially perpendicular to the to-be-processed surfaces of the to-be-processed substrates 1, and an external feed-in mechanism A which feeds the liquid or gas from the outside of the process bath TK into the tubes TB.

The tube TB has, for instance, a plurality of feed-out ports which are disposed at predetermined intervals in the axial direction (Z direction) of the tube TB. Instead of the feed-out ports, the tube TB may have, for instance, a linear feed-out port extending in parallel to the axial direction (Z direction) of the tube TB, or a plurality of feed-out ports which are disposed in a staggered fashion in the axial direction of the tube TB.

In the substrate processing apparatus according to the embodiment, compressed air is fed in the tubes TB from the external feed-in mechanism A, and the air is fed out into the process bath TK from the feed-out ports of the tubes TB. The air that is fed in the tubes TB is jetted from the feed-out ports that are formed in the surfaces of the tubes TB, and rises as bubbles in the polishing liquid LQ. Thereby, the polishing liquid LQ in the process bath TK is stirred.

As shown in FIG. 2A and FIG. 2B, a plurality of substantially rectangular, planar rectifying plates PL1 are disposed between the bottom surface of the substrate processing apparatus and the to-be-processed substrates 1. Each rectifying plate PL1 is a substantially rectangular, planar plate that is formed of a material such as vinyl chloride resin, which is not easily polished even if immersed in the polishing liquid LQ.

The rectifying plates PL1 are disposed near the to-be-processed substrates 1. For example, the rectifying plates PL1 may be attached to the cassette in which the to-be-processed substrates 1 are stored, or may be fixed at predetermined positions in the process bath TK by fixing members.

The rectifying plates PL1, as shown in FIG. 2A and FIG. 2B, are disposed such that a distance D1 between their end portions on the to-be-processed substrate 1 side and the to-be-processed substrates 1 is less than a distance D2 between their end portions on the bottom side of the substrate processing apparatus and upper ends of the tubes TB.

As shown in FIG. 2A and FIG. 2B, each rectifying plate PL1 is disposed such that the major surface thereof (substantially parallel to the XY plane) extends substantially in parallel to the to-be-processed surface of the to-be-processed substrate 1, and that the longitudinal direction (X direction) of the substantially rectangular major surface thereof is substantially perpendicular to the direction in which the tubes TB extend.

The length in the longitudinal direction (X direction) of the major surface of each rectifying plate PL1 is substantially equal to the length in the X direction of the to-be-processed surface of each to-be-processed substrate 1. It is preferable that the length in a direction (Y direction) substantially perpendicular to the longitudinal direction of the major surface of the rectifying plate PL1 be 0.3 times or more of the width dimension with which the processing of the to-be-processed substrate 1 becomes non-uniform if the rectifying plate PL1 is not disposed.

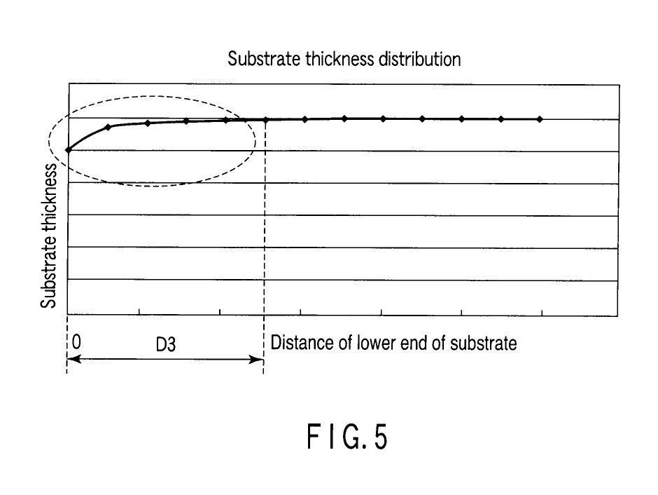

For example, as shown in FIG. 5, the thickness of the to-be-processed substrate 1 becomes non-uniform at a predetermined position of a lower end E1 of the to-be-processed substrate 1 in a case where the to-be-processed substrate 1 is subjected to a polishing process without the rectifying plate PL1 being disposed. In the graph of FIG. 5, the abscissa indicates a distance D3 from the lower end E1 of the to-be-processed substrate 1 in the Y direction, and the ordinate indicates the thickness (the width in the Z direction) of the to-be-processed substrate 1 in the distance D3.

In the case shown in FIG. 5, in the region of the distance D3 from the lower end E1 of the to-be-processed substrate 1, the thickness of the to-be-processed substrate 1 is less than a desired thickness. Specifically, in the case shown in FIG. 5, it is preferable that the length in the direction (Y direction) of the major surface of the rectifying plate PL1 be 0.3 times or more of the distance D3 from the lower end E1 of the to-be-processed substrate 1.

In the case shown in FIG. 2A and FIG. 2B, one rectifying plate PL1 is disposed in association with one to-be-processed substrate 1. However, the number of to-be-processed substrates 1 may be different from the number of rectifying plates PL1. In FIG. 2A, the to-be-processed substrates 1 and the rectifying plates PL1 are depicted as being arranged with substantially equal pitches. However, it is not necessary that the to-be-processed substrates 1 and the rectifying plates PL1 are arranged with substantially equal pitches. Besides, the major surface of the to-be-processed substrate 1 and the major surface of the rectifying plate PL1 may not necessarily be disposed substantially in parallel.

If the rectifying plates PL1 are disposed near the to-be-processed substrates 1 and the to-be-processed substrates 1 are polished, as described above, the flow of the polishing liquid LQ, which is caused by the gas (or liquid) jetted from the tubes TB, first strikes the rectifying plates PL1, and the speed of the flow is decelerated. Then, the flow is guided to run along the major surfaces of the rectifying plates PL1 in the Y direction.

Subsequently, in the polishing liquid LQ, there occur flows LF ascending to the upper part of the process bath TK along the rectifying plates PL1 and the to-be-processed surfaces (substantially parallel to the XY plane) of the to-be-processed substrates 1. Specifically, in the vicinity of the to-be-processed surfaces of the to-be-processed substrates 1, there occur upward flows FL of the polishing liquid LQ, which are substantially parallel to the to-be-processed surfaces of the to-be-processed substrates 1.

As a result, it is possible to prevent the polishing process of the to-be-processed substrates 1 from progressing only at the vicinity of the feed-out ports of the tubes TB, and to polish the to-be-processed substrates 1 with uniform thickness. Thereby, the product performance and manufacturing yield of liquid crystal display devices can be improved.

That the thickness of the to-be-processed substrate 1 becomes uniform means, for example, the case in which the difference in thickness (width in the Z direction) between a thickest part and a thinnest part of the to-be-processed substrate 1, or each of the first substrate 101M and second substrate 102M, becomes a predetermined value or less. In the substrate processing apparatus according to the present embodiment, the difference in thickness (width in the Z direction) between a thickest part and a thinnest part of the to-be-processed substrate 1 is about 1.5 μm or less.

Therefore, the present embodiment can provide a substrate processing apparatus which can reduce a variance in thickness within a substrate surface or between substrates, and can improve product performance and manufacturing yield.

Next, a substrate processing apparatus according to a second embodiment of the present invention is described with reference to the accompanying drawings. In the description below, the structural parts common to those of the substrate processing apparatus according to the above-described first embodiment are denoted by like reference numerals, and a description thereof is omitted.

The substrate processing apparatus according to the present second embodiment, like the substrate processing apparatus according to the above-described first embodiment, is a substrate processing apparatus which is used when the to-be-processed substrate 1, which is a to-be-processed body, is subjected to cleaning, film formation or etching with use of a liquid or a gas.

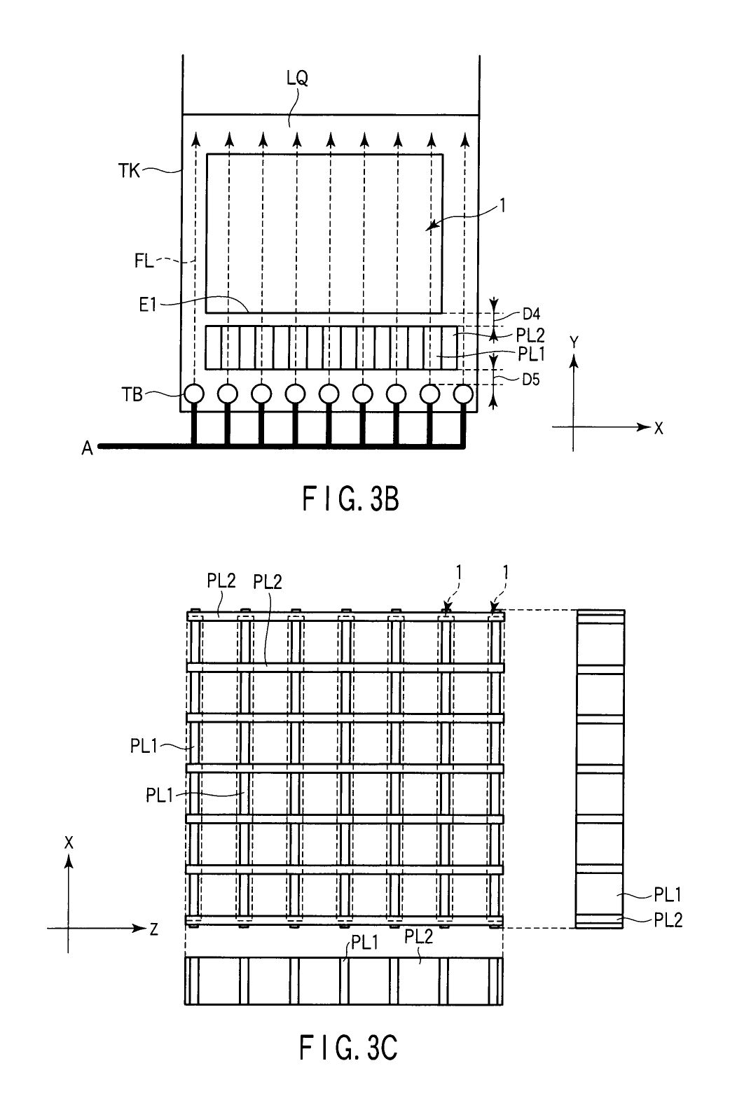

As shown in FIG. 3A and FIG. 3B, the to-be-processed substrates 1 are arranged and disposed in a cassette or the like, and the to-be-processed substrates 1 in the cassette are immersed in the polishing liquid in the process bath TK. The to-be-processed substrates 1 are arranged such that their to-be-processed surfaces (substantially parallel to an XY plane) are substantially perpendicular to the bottom surface (substantially parallel to a ZX plane) of the process bath TK and that the to-be-processed surfaces are juxtaposed at intervals so as not to contact each other.

A plurality of substantially rectangular, planar rectifying plates PL1 and PL2 are disposed between the bottom surface of the substrate processing apparatus and the to-be-processed substrates 1. The rectifying plates PL1 and PL2 are disposed near the to-be-processed substrates 1. For example, the rectifying plates PL1 and PL2 may be attached to the cassette in which the to-be-processed substrates 1 are stored, or may be fixed at predetermined positions in the process bath TK by fixing members.

Specifically, the rectifying plates PL1, as shown in FIG. 3A and FIG. 3B, are disposed such that a distance D4 between their end portions on the to-be-processed substrate 1 side and the to-be-processed substrates 1 is less than a distance D5 between their end portions on the bottom side of the substrate processing apparatus and upper ends of the tubes TB.

Similarly, the rectifying plates PL2 are disposed such that a distance D4 between their end portions on the to-be-processed substrate 1 side and the to-be-processed substrates 1 is less than a distance D5 between their end portions on the bottom side of the substrate processing apparatus and upper ends of the tubes TB.

As shown in FIG. 3A, FIG. 3B and FIG. 3C, each rectifying plate PL1 is disposed such that the major surface thereof (substantially parallel to the XY plane) extends substantially in parallel to the to-be-processed surface of the to-be-processed substrate 1, and that the longitudinal direction (X direction) of the substantially rectangular major surface thereof is substantially perpendicular to the direction in which the tubes TB extend. Each rectifying plate PL2 is disposed such that the major surface thereof (substantially parallel to the ZX plane) extends substantially perpendicular to the to-be-processed surface of the to-be-processed substrate 1, and that the longitudinal direction (Z direction) of the substantially rectangular major surface thereof is substantially parallel to the direction in which the tubes TB extend.

The length in the longitudinal direction (X direction) of the major surface of each rectifying plate PL1 is substantially equal to the length in the X direction of the to-be-processed substrate 1. It is preferable that the length in a direction (Y direction) substantially perpendicular to the longitudinal direction of the rectifying plate PL1 be 0.3 times or more of the width dimension with which the processing of the to-be-processed substrate 1 becomes non-uniform if the rectifying plate PL1, PL2 is not disposed.

The length in the longitudinal direction (Z direction) of each rectifying plate PL2 is substantially equal to the distance between the to-be-processed surfaces of endmost ones of the to-be-processed substrates 1 in the direction of arrangement of the to-be-processed substrates 1. Like the case of the substrate processing apparatus according to the above-described first embodiment, it is preferable that the length in a direction (Y direction) substantially perpendicular to the longitudinal direction of the rectifying plate PL2 be 0.3 times or more of the width dimension with which the processing of the to-be-processed substrate 1 becomes non-uniform if the rectifying plate PL1, PL2 is not disposed.

If the rectifying plates PL1, PL2 are disposed near the to-be-processed substrates 1 and the to-be-processed substrates 1 are polished, as described above, the flow of the polishing liquid LQ, which is caused by the gas (or liquid) jetted from the tubes TB, first strikes the rectifying plates PL1, and the speed of the flow is decelerated. Then, the flow is guided to run along the major surfaces (substantially parallel to the XY plane) of the rectifying plates PL1 and PL2 in the Y direction.

Subsequently, in the polishing liquid LQ, there occur flows LF ascending to the upper part of the process bath TK along the rectifying plates PL1 and PL2 and the to-be-processed surfaces (substantially parallel to the XY plane) of the to-be-processed substrates 1. Specifically, in the vicinity of the to-be-processed surfaces of the to-be-processed substrates 1, there occur upward flows FL of the polishing liquid LQ, which are substantially parallel to the to-be-processed surfaces of the to-be-processed substrates 1.

As a result, it is possible to prevent the polishing process of the to-be-processed substrates 1 from progressing only at the vicinity of the feed-out ports of the tubes TB, and to polish the to-be-processed substrates 1 with uniform thickness. Thereby, the product performance and manufacturing yield of liquid crystal display devices can be improved.

Therefore, the present embodiment can provide a substrate processing apparatus which can reduce a variance in thickness within a substrate surface or between substrates, and can improve product performance and manufacturing yield.

Next, a substrate processing apparatus according to a third embodiment of the present invention is described with reference to the accompanying drawings. The substrate processing apparatus according to the present third embodiment, like the substrate processing apparatus according to the above-described first embodiment, is a substrate processing apparatus which is used when the to-be-processed substrate 1, which is a to-be-processed body, is subjected to cleaning, film formation, or etching with use of a liquid or a gas.

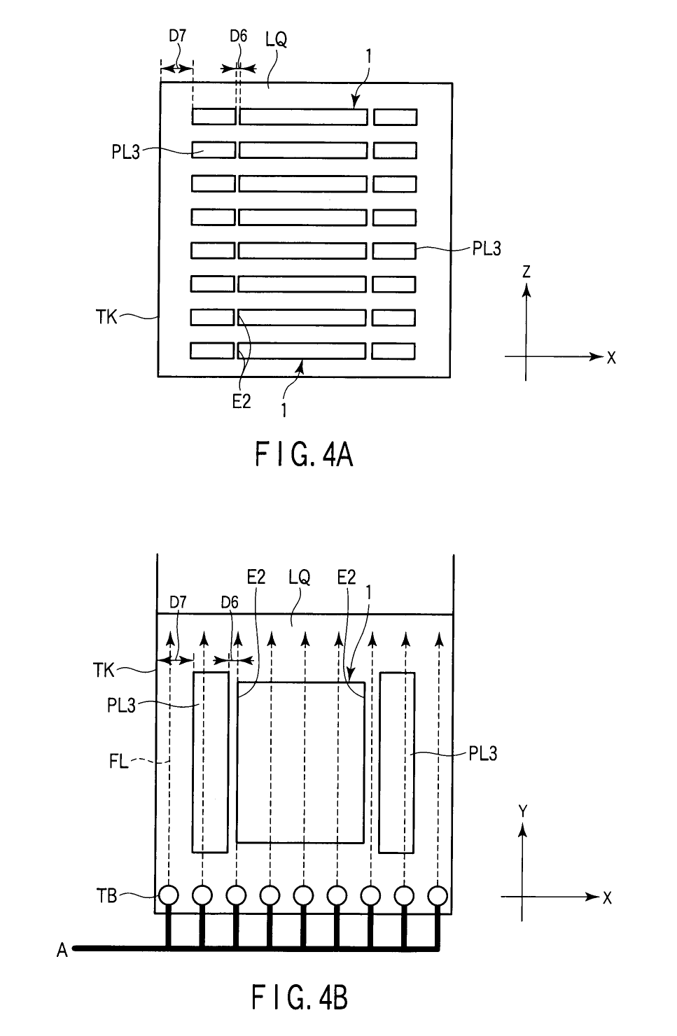

As shown in FIG. 4A, the substrate processing apparatus according to the present embodiment includes rectifying plates PL3 which are disposed near those end portions E2 of to-be-processed substrates 1, which are not opposed to the tubes TB. In the substrate processing apparatus according to the present embodiment, the rectifying plates PL3 are arranged and disposed on both sides of the to-be-processed substrates 1 in a direction (X direction) which is substantially perpendicular to the direction (Z direction) of arrangement of the to-be-processed substrates 1. For example, the rectifying plates PL3 may be attached to the cassette in which the to-be-processed substrates 1 are stored, or may be fixed at predetermined positions in the process bath TK by fixing members.

The rectifying plates PL3, as shown in FIG. 4A and FIG. 4B, are disposed such that a distance D6 between their end portions on the end portion E2 side of the to-be-processed substrates 1 and the to-be-processed substrates 1 is less than a distance D7 between their end portions on the lateral side of the process bath TK and the lateral side surface of the process bath TK.

The major surface (substantially parallel to the XY plane) of each rectifying plate PL3 is substantially parallel to major surface of the to-be-processed substrate 1. The longitudinal direction (Y direction) of the rectifying plate PL3 is substantially perpendicular to the axial direction (Z direction) of the tube TB. The length in the longitudinal direction (Y direction) of the major surface of each rectifying plate PL3 is substantially equal to the length in the Y direction of the major surface of the to-be-processed substrate 1.

In the case shown in FIG. 4B, the length in a direction (X direction) substantially perpendicular to the longitudinal direction of the major surface of the rectifying plate PL3 be 0.3 times or more of the dimension with which the processing of the to-be-processed substrate 1 becomes non-uniform. For example, when the to-be-processed substrates 1 are subjected to the polishing process without the rectifying plates PL3 being not disposed, there may be a case in which the thickness of the to-be-processed substrate 1 becomes smaller than a desired value in a predetermined width dimension range in the X direction from the end portion E2 of the to-be-processed substrate 1. In such a case, it is preferable that the length in the X direction of the major surface (substantially parallel to the XY plane) be 0.3 times or more of the width dimension in the X direction, with which the thickness of the to-be-processed substrate 1 becomes smaller.

If the rectifying plates PL3 are disposed near the to-be-processed substrates 1 and the to-be-processed substrates 1 are polished, as described above, the flow of the polishing liquid LQ, which is caused by the gas (or liquid) that is jetted from the tubes TB in the vicinity of the end portions of the to-be-processed substrates 1 in the X direction, first strikes the rectifying plates PL3, and the speed of the flow is decelerated. Then, the flow is guided to run along the major surfaces (substantially parallel to the XY plane) of the rectifying plates PL3 in the Y direction.

Since the flow of the polishing liquid LQ becomes substantially parallel to the major surfaces of the rectifying plates PL3 on both sides of the to-be-processed substrates 1 in the X direction, there occur uniform flows LF without disturbance, that is, flows FL in the Y direction, in the vicinity of the end portions E2 of the to-be-processed substrates 1 in the X direction.

As a result, it is possible to prevent the polishing process of the to-be-processed substrates 1 from progressing only at the end portions in the X direction, and to polish the to-be-processed substrates 1 with uniform thickness. Thereby, the product performance and manufacturing yield of liquid crystal display devices can be improved.

Therefore, the present embodiment can provide a substrate processing apparatus which can reduce a variance in thickness within a substrate surface or between substrates, and can improve product performance and manufacturing yield, like the substrate processing apparatus of the above-described first embodiment.

The present invention is not limited directly to the above-described embodiments. In practice, the structural elements can be modified and embodied without departing from the spirit of the invention. Each of the substrate processing apparatuses according to the first to third embodiments includes a plurality of rectifying plates PL1 to PL3. It should suffice if such rectifying plates are disposed near those parts of the to-be-processed substrates, which tend to decrease in thickness. In accordance with the processing characteristics of the processing apparatus, at least one rectifying plate, PL1 to PL3, may be disposed. Thereby, the same advantageous effects as with the substrate processing apparatuses according to the first to third embodiments may be obtained.

For example, the rectifying plates PL1 are disposed along the axial direction of the tubes TB so as to extend over the width of the to-be-processed substrates in the X direction. However, in the case where a plurality of feed-out ports are provided, the rectifying plates PL1 may be disposed only at positions corresponding to the positions of the feed-out ports.

In the first to third embodiments, the description has been given of the case where the chemical polishing process is performed by using the substrate process apparatus. The invention, however, is also applicable to substrate processing apparatuses which perform a cleaning step or a film formation step for the to-be-processed substrate 1. In this case, too, by properly disposing the rectifying plates PL1 to PL3 in the process bath TK, the flow of the cleaning liquid, which is put in the process bath TK, may be made substantially parallel to the to-be-processed surface of the to-be-processed substrate, and it is possible to prevent the cleaning from become partly insufficient, or the thickness of the formed film from becoming non-uniform.

The above-described embodiments are directed to the examples of substrate processing apparatuses which perform the process with use of a liquid. However, what is used in the process may also be a gas. In this case, an air-tight chamber may be used in place of the process bath.

Besides, what is jetted from the tubes is not limited to the gas, and may be a liquid, or a mixture of a liquid and a gas. The gas is not necessarily air, and it may be nitrogen gas, for instance. The liquid may be a cleaning liquid containing a detergent, or an acid or alkaline etchant.

Various inventions can be made by properly combining the structural elements disclosed in the embodiments. For example, some structural elements may be omitted from all the structural elements disclosed in the embodiments. Furthermore, structural elements in different embodiments may properly be combined. For example, the same advantageous effects as with the substrate processing apparatuses according to the first to third embodiments can be obtained by a substrate processing apparatus which includes the rectifying plates PL1 disclosed in the first embodiment and the rectifying plates PL3 disclosed in the third embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A substrate processing apparatus comprising a bath in which a liquid or a gas is fed, and a mechanism which feeds out a liquid or a gas into the bath, the substrate processing apparatus processing a to-be-processed substrate which is disposed in the bath,
wherein at least one rectifying plate is disposed near the to-be-processed substrate between the to-be-processed substrate and the mechanism.

2. The substrate processing apparatus according to claim 1, wherein the mechanism is disposed in a manner to feed the liquid or gas into the bath from a bottom part of the bath,
the to-be-processed substrate is disposed such that a to-be-processed surface of the to-be-processed substrate is substantially perpendicular to a bottom surface of the bath, and
said at least one rectifying plate includes a first rectifying plate whose major surface is disposed substantially parallel to the to-be-processed surface of the to-be-processed substrate.

3. The substrate processing apparatus according to claim 2, wherein said at least one rectifying plate further includes a second rectifying plate whose major surface is disposed substantially perpendicular to the to-be-processed surface of the to-be-processed substrate.

4. A substrate processing apparatus comprising a bath in which a liquid or a gas is fed, and a mechanism which feeds out a liquid or a gas into the bath, the substrate processing apparatus processing a to-be-processed substrate which is disposed in the bath,
wherein at least one rectifying plate is disposed near an end portion of the to-be-processed substrate, which is not opposed to the mechanism.

5. The substrate processing apparatus according to claim 1, wherein the rectifying plate is substantially rectangular, and
a dimension of the rectifying plate in a direction substantially perpendicular to a longitudinal direction of the rectifying plate is 0.3 times or more of a dimension with which a process of the to-be-processed substrate becomes non-uniform.

6. The substrate processing apparatus according to claim 4, wherein the rectifying plate is substantially rectangular, and
a dimension of the rectifying plate in a direction substantially perpendicular to a longitudinal direction of the rectifying plate is 0.3 times or more of a dimension with which a process of the to-be-processed substrate becomes non-uniform.

7. The substrate processing apparatus according to claim 1, wherein the to-be-processed substrate includes:
a first substrate having a first region which includes a plurality of first electrodes which are arrayed in a matrix; and
a second substrate having a second region which includes a second electrode which is disposed to be opposed to the plurality of first electrodes.
